(19) United States
(12) Patent Application Publication
(10) Pub. No.: US 2008/0288344 A1
(43) Pub. Date: Nov. 20, 2008

(54) SYSTEM FOR TIERED BIDDING IN AN ONLINE INFORMATION SYSTEM BASED ON THE INTEGRITY OF NETWORK INTERACTIONS

(75) Inventor: John J. Thrall, San Francisco, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/749,476

(22) Filed: May 16, 2007

(51) Int. Cl. G06Q 40/00; G06Q 30/00

(52) U.S. Cl. 705/14; 705/37

(57) ABSTRACT

A system is described for bidding in an online information system on tiers for a search term or group of terms in a search request based on the integrity of the network interaction which generated the search request. The system may include a processor, an interface and a memory. The memory may be operatively connected to the processor, and the interface, and may store a plurality of integrity tiers, a term, and a plurality of bid amounts. The interface may be operatively connected to the memory and the processor and may communicate with the advertisers. The processor may identify the plurality of integrity tiers. The processor may receive a plurality of bid amounts, from an advertiser via the interface, associated with the term and the plurality of integrity tiers. The processor may store the plurality of bid amounts in the memory.

### TECHNICAL FIELD

The present description relates generally to a system and method, generally referred to as a system, for tiered bidding based on the integrity of network interactions, and more particularly, but not exclusively, to tiered bidding based on the integrity of network interactions in an auction based online advertisement serving system.

### BACKGROUND

Online advertising may be an important source of revenue for enterprises engaged in electronic commerce. A number of different kinds of page-based online advertisements are currently in use, along with various associated distribution requirements, advertising metrics, and pricing mechanisms. Processes associated with technologies such as Hypertext Markup Language (HTML) and Hypertext Transfer Protocol (HTTP) may enable a page to be configured to contain a location for inclusion of an advertisement. An advertisement may be selected for display each time the page is requested, for example, by a browser or server application.

Some advertisement serving systems may allow an advertiser to place a bid on a keyword or query. If a web surfer searches for the search term the advertiser bid on, the advertiser's advertisement may be displayed to the web surfer. The advertiser may pay a fee to the search engine marketing system provider when the web surfer clicks through on the advertisement, sometimes referred to as pay per click online advertising.

The pay per click model may be vulnerable to a type of internet crime called click fraud. Click fraud may occur when a person, automated script, or computer program imitates a legitimate user of a web browser clicking on an ad, for the purpose of generating a charge per click without having actual interest in the target of the ad's link. The click fraud may result in the advertiser being charged for invalid or fraudulent clicks. Proving click fraud may be very difficult, since it may be hard to identify the user performing the click and what their intentions may be.

### SUMMARY

A system for tiered bidding in an online information system based on the integrity of network interactions may include a processor, an interface and a memory. The memory may be operatively connected to the processor, and the interface, and may store a plurality of integrity tiers, a term, and a plurality of bid amounts. The interface may be operatively connected to the memory and the processor and may communicate with the advertisers. The processor may identify the plurality of integrity tiers. The processor may receive a plurality of bid amounts, from an advertiser via the interface, based on the term and the plurality of integrity tiers. The processor may store the plurality of bid amounts in the memory.

A method for tiered bidding in an online information system based on the integrity of network interactions may identify a plurality of integrity tiers representing a plurality of integrity levels of a plurality of network interactions. A plurality of bid amounts relating to the plurality of integrity tiers may be received from an advertiser for a given search term. The plurality of bid amounts may be stored in a data structure.

A method for serving advertisements based on the integrity of a network interaction relating to a term may receive a network interaction relating to a term from a user. The integrity of the network interaction may be determined. A plurality of bid amounts from a plurality of advertisers relating to the integrity of the network interaction and the term may be identified. A plurality of advertisements may be served to the user based on the plurality of bid amounts.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a system for tiered bidding in an online information system based on the integrity of network interactions.

FIG. 2 is block diagram of a simplified view of a network environment implementing the system of FIG. 1 or other systems for tiered bidding in an online information system based on the integrity of network interactions.

FIG. 3 is a block diagram illustrating an advertisement serving system implementing the system of FIG. 1 or other systems for tiered bidding in an online information system based on the integrity of network interactions.

FIG. 4 is a flowchart illustrating the operations of serving advertisements in the systems of FIG. 1, or other systems for tiered bidding in an online information system based on the integrity of network interactions.

FIG. 5 is a flowchart illustrating the operations of determining the amount to bill a revenue generator in the systems of FIG. 1, or other systems for tiered bidding in an online information system based on the integrity of network interactions.

FIG. 6 is a flowchart illustrating the operations of a revenue generator in the systems of FIG. 1, or other systems for tiered bidding in an online information system based on the integrity of network interactions.

FIG. 7 is a screenshot of a search results page displaying advertisements to the users 120-N served from a system implementing the system of FIG. 1 or other systems for tiered bidding in an online information system based on the integrity of network interactions.

FIG. 8 is an illustration a general computer system that may be used in the system of FIG. 1 or other systems for tiered bidding in an online information system based on the integrity of network interactions.

### DETAILED DESCRIPTION

A system and method, generally referred to as a system, relate to tiered bidding in an online information system based on the integrity of network interactions, and more particularly, but not exclusively, to tiered bidding based on the integrity of network interactions in an auction based online advertisement serving system. The principles described herein may be embodied in many different forms.

The system may be utilized in an auction based online advertising system to create individual marketplaces for a plurality of tiers of integrity for each search term. Advertisers may be able to place individual bids on search terms generated by network interactions of different levels of integrity, such as low integrity interactions and high integrity interactions. When a user searches for a term, the integrity of the resulting network interaction may be determined based on data relating to the user who performed the search, such as a trust level associated with the user. The system may determine bid amounts of the advertisers for the search term and the determined integrity tier and may use the bid amounts in the advertisement serving process.

The system may be utilized to implement a service allowing advertisers to specify a minimum percentage of high integrity interactions they wish their advertisement to be displayed to each month, or any other time period. The system may throttle serving the advertisements to high integrity interactions and/or low integrity interactions to meet the minimum percentage. Advertisers may pay an additional fee for this service.

Advertisers with existing bids may opt-in to the system by specifying a premium percentage to be applied to their existing bids. In this case bids for a high integrity tier may be determined by multiplying the existing bids of the advertisers by the premium percentage. The bids for a low integrity tier may be represented by the original bids of the advertisers.

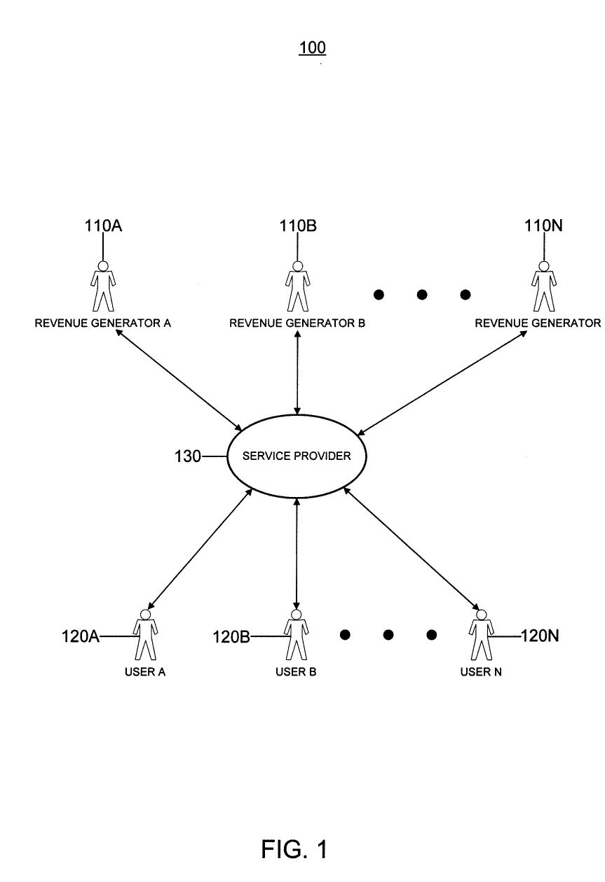

FIG. 1 provides a general overview of a system 100 for tiered bidding in an online information system based on the integrity of network interactions. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more revenue generators 110A-N, such as advertisers, a service provider 130, such as a search engine marketing service provider, and one or more users 120A-N, such as web surfers or consumers. The service provider 130 may implement an advertising campaign management system incorporating an auction based and/or non-auction based advertisement serving system. The revenue generators 110A-N may pay the service provider 130 to serve, or display, advertisements of their goods or services, such as on-line advertisements, on a network, such as the Internet. The advertisements may include sponsored listings, banners ads, popup advertisements, or generally any way of attracting the users 120A-N to the web site of the revenue generators 110A-N.

The amount the revenue generators 110A-N may pay the service provider 130 to serve, or display, advertisements may be based on one or more factors. These factors may include impressions, click throughs, conversions, and/or generally any metric relating to the advertisement and/or the behavior of the users 120A-N. The impressions may refer to the number of times an advertisement may have been displayed to the users 120A-N. The click throughs may refer to the number of times the users 120A-N may have clicked through the advertisement to the websites of the revenue generators 110A-N. The conversions may refer to the number of times a desired action was taken by the users 120A-N after clicking through on the websites of the revenue generators 110A-N. The desired actions may include submitting a sales lead, making a purchase, viewing a key page of the site, downloading a whitepaper, and/or any other measurable action. If the desired action is making a purchase, then the revenue generators 110A-N may pay the service provider 130 a percentage of the purchase.

The users 120A-N may be consumers of goods or services who may be searching for a business, such as the business of one of the revenue generators 110A-N. Alternatively or in addition the users 120A-N may be machines or other servers, such as the third party server 250. The users 120A-N may supply information describing themselves to the service provider 130, such as the location, gender, or age of the users 120A-N, or generally any information that may be required for the users 120A-N to utilize the services provided by the service provider 130. The users 120A-N may supply information describing themselves to the service provider 130 as part of a registration process. When one of the users 120A-N, such as the user A 120A completes the registration process, the user A 120A may be assigned a unique user ID. The users 120A-N may use their user ID to utilize the services offered by the service provider 130. The registration process may further include a number of security measures that may prevent the automated creation of user IDs, such as, text in the form of images that may only be read by humans, password protection for each sign-in, terms of use restrictions, or generally any security measure capable of ensuring the users 120A-N are people and not machines.

The users 120A-N who have completed the registration process, and may be identifiable by their unique user IDs, may be referred to as “trusted” users. Newly registered user IDs may be quarantined into an “unknown” category or may be categorized as “not trusted” until sufficient data can be collected to determine whether the user is trustworthy. The service provider 130 may further granulate, or identify, the trustworthiness of the users 120A-N by utilizing other information associated with the users 120A-N. This information may include whether the users 120A-N have submitted a valid payment mechanism to the service provider 130, such as a credit card, cell phone account, or any other mechanism for making payments to the service provider 130, how long the users 120A-N have been registered with the service provider 130, whether the users 120A-N are actively using other services of the service provider 130, such as email, or generally any information that may indicate whether the users 120A-N are trustworthy. The users 120A-N may submit a payment mechanism, such as a credit card, to utilize services of the service provider 130 such as a wallet service, premium services, third party services, age verification, or generally any service that may requires a payment mechanism and/or payment mechanism verification. If a user A 120A has a valid payment mechanism registered with the service provider 130, such as a credit card, there may be a higher probability that the user A 120A is trustworthy.

The service provider 130 may utilize the trustworthiness of a user to determine the integrity of an interaction with the user. An interaction with a trusted user may have a higher probability of being valid, and therefore may be referred to as a high integrity interaction. An interaction with a not trusted user may have a lower probability of being valid, and therefore may be referred to as a low integrity interaction. A valid interaction may be one generated by an actual user, with a genuine interest in the term searched for and/or the advertisements of the revenue generators 110A-N. An invalid interaction may be one generated when a person, automated script, or computer program imitates a legitimate user of a web browser clicking on an ad, for the purpose of generating a charge per click without having actual interest in the target of the ad's link.

The revenue generators 110A-N may prefer high integrity interactions and may be willing to pay a premium for high integrity interactions because high integrity interactions may be more likely to result in conversions. Furthermore, the service provider 130 may refund the revenue generators 110A-N for click throughs that are identified as invalid, which may be a result of a low integrity interaction. Therefore it may be beneficial for the service provider 130 to categorize each interaction based on the probably integrity of the interaction. There may be a plurality of categories, or tiers, indicating the integrity of the interactions. Alternatively or in addition the service provider may create a plurality of categories, or tiers, identifying the trustworthiness of the users 120A-N.

The service provider 130 may also utilize data from a fraud detection system to supplement the data related to the trustworthiness of the users 120A-N. The aggregated information may be used to determine the integrity of interactions. The fraud detection system may be implemented by the service provider 130 or a third party. The fraud detection system may utilize the user IDs of the users 120A-N to track the behavior of the users 120A-N. The fraud detection system may maintain an entire behavioral history of the users 120A-N based on the user IDs. The behavioral history may include information relating to complaints submitted by the revenue generators 110A-N about interactions with the users 120A-N. The complaints may relate to invalid interactions generated by the users 120A-N.

In the system 100, the revenue generators 110A-N may interact with the service provider 130, such as via a web application. The revenue generators 110A-N may send information, such as billing, website and advertisement information, to the service provider 130 via the web application. The web application may include a web browser or other application such as any application capable of displaying web content. The application may be implemented with a processor such as a personal computer, personal digital assistant, mobile phone, or any other machine capable of implementing a web application.

The users 120A-N may also interact individually with the service provider 130, such as via a web application. The users 120A-N may interact with the service provider 130 via a web based application or a standalone application. The service provider 130 may communicate data to the revenue generators 110A-N and the users 120A-N over a network. The following examples may refer to a revenue generator A 110A as an online advertiser; however the system 100 may apply to any revenue generators 110A-N who may utilize a system for tiered bidding based on the integrity of network interactions.

In operation, one of the revenue generators 110A-N, such as revenue generator A 110A, may provide information to the service provider 130. This information may relate to the transaction taking place between the revenue generator A 110A and the service provider 130, or may relate to an account the revenue generator A 110A maintains with the service provider 130. In the case of a revenue generator A 110A who is an online advertiser, the revenue generator A 110A may provide initial information necessary to open an account with the service provider 130. The revenue generators 110A-N may implement one or more advertising tactics with the service provider 130 to target advertisements to the users 120A-N. Alternatively or in addition the revenue generators 110A-N may authorize the service provider 130 to use any advertising tactic, or method, to display their advertisements to the users 120A-N.

One example of an advertising tactic may be sponsored search, such as targeting advertisements to search terms or keywords. Sponsored search may operate within the context of an auction-based system or marketplace that may be used by the revenue generators 110A-N to bid for search terms or groups of terms. In a system for tiered bidding based on the integrity of network interactions the revenue generators 110A-N may place individual bids on different integrity tiers of interaction. For example, the revenue generators 110A-N may place two separate bids on each search term or groups of terms. One bid may be for search terms generated by high integrity interactions and another bid may be for search terms generated by low integrity interactions. When an interaction occurs, the bid tier applied to the interaction may depend on the integrity of the interaction determined by the service provider 130. For example, if the service provider 130 determines that a search term was generated by a low integrity interaction, the low integrity bids may be utilized.

Alternatively or in addition the revenue generators 110A-N may place a plurality of bids on each search term or groups of terms based on different tiers of interaction integrity. The service provider 130 may identify a plurality of tiers by which the integrity of interactions may be categorized. For example, there may be a “high integrity” tier, a “middle integrity” tier and a “low integrity” tier. An interaction may be categorized into a tier based on the trustworthiness of the users 120A-N generating the interaction. The revenue generators 110A-N may place a bid in one or more of the integrity tiers. Alternatively or in addition the revenue generators 110A-N may place bids on tiers identifying the trustworthiness of the users 120A-N.

When the user A 120A interacts with the service provider 130, such as by clicking through on an advertisement, the service provider 130 may determine the trustworthiness of the interaction generated by the user A 120A. The trustworthiness of the user A 120A may then be used to determine the integrity tier of the interaction. Once the integrity tier is determined the service provider 130 may determine the bid order by applying the highest bid of the revenue generators 110A-N, for the integrity tier of the interaction, or any tier below the integrity tier of the interaction, since higher integrity interactions may be more valuable than lower integrity interactions. For example, if the revenue generator A 110A placed a bid on the given search term for low integrity interactions, but not for any other interaction integrity tiers, the bid for the low integrity tier may be applied to middle integrity and/or high integrity interactions.

In some instances the revenue generators 110A-N may not be able to place bids on high integrity interactions without placing bids on middle or low integrity interactions. For example, the revenue generators 110A-N may not be able to bid on high integrity interactions unless they have bid on low integrity interactions. The bids of the revenue generators 110A-N on low and middle integrity interactions may be analyzed for validity, such as to prevent token bids that may never result in the display of the advertisement of the revenue generators 110A-N. This may prevent revenue generators 110A-N from only bidding on the more desirable high integrity interactions.

Alternatively or in addition the revenue generators 110A-N may be able to specify a premium percentage they may be willing to pay for the highest interaction integrity tier. For example, the revenue generator A 110A may place a bid applicable to all integrity tiers, for $1, and may place a 25% premium percentage on high integrity interactions. In this case the revenue generator A 110A may be bidding a 25% premium on the $1 bid, or $1.25, for high integrity interactions, and $1 for all other interactions. The revenue generators 110A-N may be able to set a high integrity premium percentage for each individual term or groups of terms bid on, or may be able to set a high integrity premium percentage on a global basis across all terms or groups of terms bid on.

The revenue generators 110A-N may also be able to opt in to specify a minimum percentage of the highest integrity interactions, their advertisement should be displayed to each month, or any other time period. For example, the revenue generator A 110A may specify a minimum percentage of highest integrity interactions of 25%. In this case, the service provider 130 may throttle the serving of the advertisement of the revenue generator A 110A to low integrity interactions when the percentage of high integrity interactions drops below 25%. Throttling the serving of the advertisement may mean the service provider 130 may not display the advertisement of the revenue generator A 110A until the percentage of high integrity interactions reaches 25%. If the revenue generators 110A-N opt in to specify the minimum percentage of high integrity interactions, the revenue generators 110A-N may pay a monthly fee to the service provider 130. Revenue generators 110A-N paying a monthly fee may only specify one bid across all tiers of interactions. Alternatively or in addition the revenue generators 110A-N may be able to specify a minimum number of conversions or a minimum number of any other metric used to measure the effectiveness of an advertisement.

Alternatively or in addition the revenue generators 110A-N, such as the revenue generator A 110A, may be able to opt into a bid multiplier program for each term or group of terms. In this case when the user A 120A interacts with the service provider 130 the service provider may determine the probability or likelihood that the interaction generated by the user A 120A is a valid interaction. The probability calculation may be performed by the service provider 130 or a third party. The probability may be an integer from 0 to 1, where 0 may represent a fraudulent user and 1 may represent a valid user. The more likely that the interaction generated by the user A 120A may be a valid interaction the higher the probability may be. Once the probability is calculated, the probability may be multiplied by the bid of the revenue generator A 110A for the search term. For example, if the bid was $1.00 and the probability that the user A 120A is a valid user is 0.5, then the bid may be adjusted to $0.50 ($1.00*.5). The revenue generators 110A-N may pay a recurring fee to participate in the bid multiplier program.

When the terms are used in a search, the ad listings or links of a revenue generator, such as the revenue generator A 110A, may be displayed among the search results. The revenue generator A 110A may further bid for position or prominence of their listings in the search results. With regard to auction-based sponsored search, the revenue generator A 110A may provide a uniform resource locator (URL) for the webpage to which the ad may take the users 120A-N to if clicked on. The revenue generator A 110A may also provide the text or creative of the advertisement that may be displayed in connection with the URL. The revenue generator A 110A may then pay the service provider 130 for the click. The bid amount paid to the service provider 130 may depend on whether the interaction that resulted in the click-through was identified as a valid interaction or an invalid interaction.

Another example of an advertising tactic may be content matching. Content matching advertisements may be used by the revenue generator A 110A to complement, or as alternative to, the sponsored search tactic. Ads stored according to the content matching tactic may be displayed alongside relevant articles, product reviews, etc, presented to the users 120A-N. The system 100 may implement a content matching system. The content matching system may process the words on a given page to determine a set of terms. The set of terms may be the most commonly occurring words, or may be determined by some other factor. The set of terms may then be used to determine which of the content matching advertisements to display. The content matching system may use the set of terms to select advertisements, such as by selecting the advertisements which contain the most number of words matching the set of terms.

Content matching advertisements may be displayed on any web page containing content relevant to the advertisement. For the content matching tactic, the revenue generator A 110A may provide one or more URLs identifying the address of a webpage a given ad may take the users 120A-N to if clicked on. The revenue generator A 110A may also provide the text, image, video or other type of multimedia comprising the creative portion of the advertisement that may be displayed next to the URL.

Another example of an advertising tactic may be a banner advertisement or popup advertisement. The banner ad and/or popup ad tactic may be used by the revenue generators 110A-N to complement, or as alternative to, the sponsored search tactic and the content match tactic. In contrast to the sponsored search tactic and content match tactic, which may be based on a pay-per-click payment scheme, a revenue generator 110A-N may pay for every display of a banner ad and/or popup ad, referred to as an impression. The revenue generators 110A-N may pay the bid amount associated with the integrity tier of the interaction resulting in the impression. Alternatively, if the banner ad and/or popup ad displays a phone number, a revenue generator, such as the revenue generator A 110A may only be billed if a user, such as the user A 120A, calls the phone number associated with the advertisement (“pay-per-call”). Thus, for the banner ad and/or popup ad tactic, the revenue generator A 110A may provider a URL to the webpage where the ad may take the user A 120A if clicked on, as well as the creative or the given banner ad and/or popup ad.

A revenue generator A 110A who is an online advertiser may maintain several accounts with the service provider 130. For each account the revenue generator A 110A may maintain several advertising campaigns, such as an MP3 player campaign, a car campaign, or any other distinguishable category of products and/or services. Each campaign may include one or more ad groups. The ad groups may further distinguish the category of products and/or services represented in the advertising campaign, such as by search tactic, performance parameter, demographic of user, family of products, or almost any other parameter desired by the revenue generators 110A-N.

For example, if the advertising campaign is for MP3 Players, there may be an ad group each brand of MP3 players, such as APPLE IPOD® or MICROSOFT ZUNE®. Allowing the revenue generators 110A-N to determine their own ad groups may allow the service provider 130 to provide more useful information to the revenue generators 110A-N. The revenue generators 110A-N may thereby display, manage, optimize, or view reports on, advertisement campaign information in a manner most relevant to a revenue generator, such as the revenue generator A 110A.

The ad groups may include one or more listings. A listing may include a title, a description, one or more search keywords, an advertisement, a destination URL, and a bid amount. A listing may represent an association between the one or more search keywords identified by the revenue generator A 110A, and an advertisement of the revenue generator A 110A.

The title may be the name of the product being advertised, such as “JEEP WRANGLER®.” The description may describe the product being advertised. For example, if DAIMLERCHRYSLER® wished to advertise a DAIMLERCHRYSLER JEEP WRANGLER®, the listing may have a description of “DAIMLERCHRYSLER JEEP WRANGLER®,” “JEEP WRANGLER®,” or “5 PASSENGER JEEP WRANGLER®.”

The destination URL may represent the link the revenue generator A 110A wishes a user A 120A to be directed to upon clicking on the advertisement of the revenue generator A 110A, such as the home page of the revenue generator A 110A. The bid amount may represent a maximum amount the revenue generator A 110A may be willing to pay each time a user A 120A may click on the advertisement of the revenue generator A 110A or each time the advertisement of the revenue generator A 110A may be shown to a user A 120A.

The keywords may represent one or more search terms that the revenue generator A 110A may wish to associate their advertisement with. When a user A 120A searches for one of the listing's keywords, the advertisement of the revenue generator A 110A may be displayed on the search results page.

Alternatively or in addition, the service provider 130 may implement a query suggestion system. A query suggestion system may perform an analysis on the query of the user A 120A, or the query determined from, or related to, the content of page, such as a web page displayed to the user A 120A, to find additional queries that may relate to the query of the user A 120A, or the query determined from the content of a page. If additional queries are found, advertisements with bids on any of the additional queries may be displayed to the user A 120A in addition to the advertisements with bids on the original query. Thus the user A 120A may click on an advertisement of a revenue generator A 110A who did not bid on the query the user A 120A searched for, or the query determined from the content of a page, but a query matched to the query by a query suggestion system. Some examples of query suggestion systems may include King Kong, SPM, MOD, Units, or query suggestions derived from a network of advertisers and users.

More detail regarding the aspects of query suggestions systems, as well as their structure, function and operation, can be found in commonly owned U.S. patent application Ser. No. 10/625,082, filed on Jul. 22, 2003, entitled, “TERM-BASED CONCEPT MARKET”; U.S. patent application Ser. No. 11/295,166, filed on Dec. 5, 2005, entitled “SYSTEMS AND METHODS FOR Managing and Using Multiple Concept Networks for ASSISTED SEARCH PROCESING”; U.S. patent application Ser. No. 10/797,586, filed on Mar. 9, 2004, entitled “VECTOR ANALYSIS OF HISTOGRAMS FOR UNITS OF A CONCEPT NETWORK IN SEARCH QUERY PROCESSING”; U.S. patent application Ser. No. 10/797,614, filed on Mar. 9, 2004, entitled “SYSTEMS AND METHODS FOR SEARCH PROCESSING USING SUPERUNITS”; U.S. Pat. No. 7,051,023, filed on Nov. 12, 2003, entitled “SYSTEMS AND METHODS FOR GENERATING CONCEPT UNITS FROM SEARCH QUERIES,” and U.S. Pat. No. 6,876,997, filed on May 22, 2000, entitled “METHOD AND APPARATUS FOR IDENTIFYING RELATED SEARCHES IN A DATABASE SEARCH SYSTEM, all of which are hereby incorporated herein by reference in their entirety. The systems and methods herein associated with query suggestion systems analysis may be practiced in combination with methods and systems described in the above-identified patent applications incorporated by reference.

For example, a revenue generator A 110A, such as DAIMLERCHRYSLER®, may desire to target an online advertisement for a CHRYSLER JEEP WRANGLER® to users 120A-N searching for the keywords “JEEP®”, “WRANGLER®”, or “JEEP WRANGLER®”. DAIMLERCHRYSLER® may place a bid with the service provider 130 for the search keywords “JEEP®”, “WRANGLERS”, and “JEEP WRANGLER®” and may associate the online advertisement for a CHRYSLER JEEP WRANGLERS with the keywords. The advertisement of the revenue generator A 110A may be displayed when one of the users 120A-N searches for the keywords “JEEP®”, “WRANGLER®”, or “JEEP WRANGLER®”.

An advertisement may represent the data the revenue generator A 110A wishes to be displayed to a user A 120A when the user A 120A searches for one of the listing's keywords. An advertisement may include a combination of the description and the title. The ad groups may each contain several different advertisements, which may be referred to as creatives. Each of the individual advertisements in an ad group may be associated with the same keywords. The advertisements may differ slightly in creative aspects or may be targeted to different demographics of the users 120A-N.

There may be some instances where multiple revenue generators 110A-N may have bid on the same search keyword. The service provider 130 may serve to the users 120A-N the online advertisements that the users 120A-N may be most likely to click on. For example, the service provider 130 may include a relevancy assessment to determine the relevancy of the multiple online advertisements to the search keyword. The more relevant an advertisement may be to the keyword the more likely it may be that the user A 120A may click on the advertisement. The relevancy may be determined by the service provider 130 or a third party relevancy engine.

When one of the users 120A-N, such as the user A 120A, interacts with the service provider 130, such as by searching for a keyword, the service provider 130 may retain data describing the interaction with the user A 120A. The saved data may include the keyword searched for, the geographic location of the user A 120A, and the date/time the user A 120A interacted with the service provider 130. The data may also generally include any data available to the service provider 130 that may assist in describing the interaction with the user A 120A, or describing the user A 120A. The service provider 130 may also store data that indicates whether an advertisement of one of the revenue generators 110A-N, such as the revenue generator A 110A was displayed to the user A 120A, and whether the user A 120A clicked on the advertisement.

The users 120A-N may supply information relating to their geographic location and/or other descriptive information upon their initial interaction with the service provider 130. Alternatively or in addition the service provider 130 may obtain the location of the user A 120A based on the IP address of the user A 120A. The service provider 130 may use a current date/time stamp to store the date/time when the user A 120A interacted with the service provider 130.

The service provider 130 may generate reports based on the data collected from the user interactions and communicate the reports to the revenue generators 110A-N to assist the revenue generators 110A-N in measuring the effectiveness of their online advertising. The reports may indicate the number of times the users 120A-N searched for the keywords bid on by the revenue generators 110A-N, the number of times each advertisement of the ad groups of the revenue generators 110A-N was displayed to the users 120A-N, the number of times the users 120A-N clicked through on each advertisement of the ad groups of the revenue generators 110A-N, and/or the number of times a desired action was performed by the users 120A-N after clicking through on an advertisement. The reports may also generally indicate any data that may assist the revenue generators 110A-N in measuring or managing the effectiveness of their online advertising.

The reports may further include sub-reports that segment the data into more specific categories, including the time intervals when the interactions occurred, such as weeknights primetime, weekends, etc., the demographics of the users 120A-N, such as men ages 18-34, the location of the users 120A-N. The reports may also generally include any other data categorization that may assist the revenue generators 110A-N in determining the effectiveness of their online advertising.

More detail regarding the aspects of auction-based systems, as well as the structure, function and operation of the service provider 130, as mentioned above, can be found in commonly owned U.S. patent application Ser. No. 10/625,082, filed on Jul. 22, 2003, entitled, “TERM-BASED CONCEPT MARKET”; U.S. patent application Ser. No. 10/625,000, file on Jul. 22, 2003, entitled, “CONCEPT VALUATION IN A TERM-BASED CONCEPT MARKET” filed on Jul. 22, 2003; U.S. patent application Ser. No. 10/625,001, filed on Jul. 22, 2003, entitled, “TERM-BASED CONCEPT INSTRUMENTS”; and U.S. patent application Ser. No. 11/489,386, filed on Jul. 18, 2006, entitled, “ARCHITECTURE FOR AN ADVERTISEMENT DELIVERY SYSTEM,” all of which are hereby incorporated herein by reference in their entirety. The systems and methods herein associated with ad campaign management may be practiced in combination with methods and systems described in the above-identified patent applications incorporated by reference.

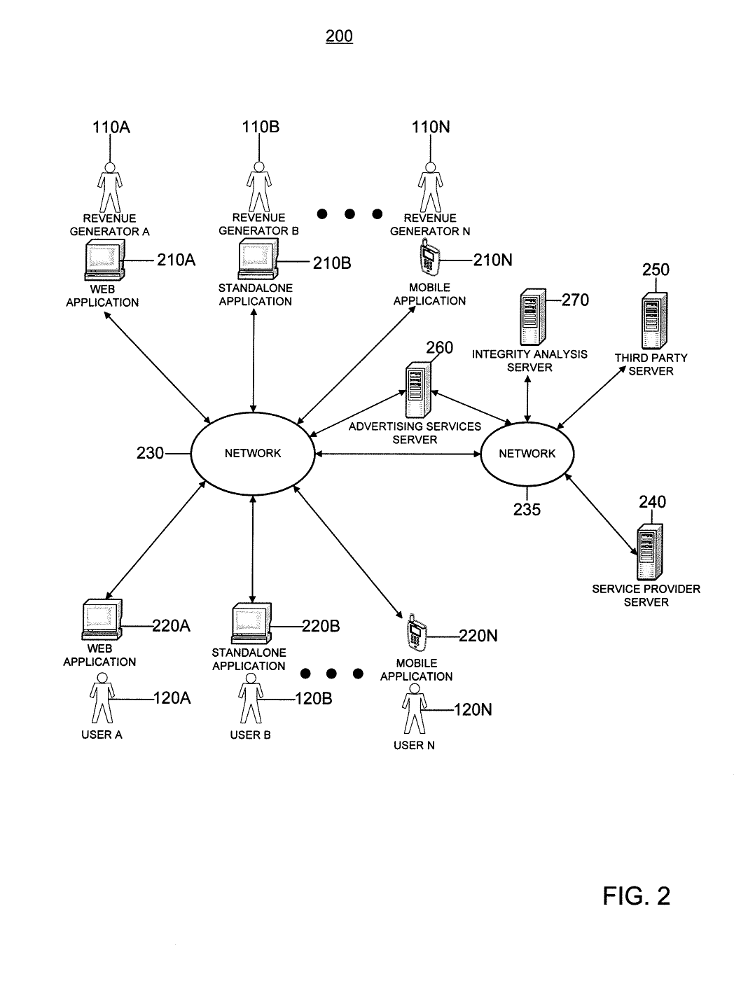

FIG. 2 provides a simplified view of a network environment 200 implementing the system of FIG. 1 or other systems for tiered bidding in an online information system based on the integrity of network interactions. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 200 may include one or more web applications, standalone applications and mobile applications 210A-N, which may be collectively or individually referred to as client applications for the revenue generators 110A-N. The system 200 may also include one or more web applications, standalone applications, mobile applications 220A-N, which may collectively be referred to as client applications for the users 120A-N, or individually as a user client application. The system 200 may also include a network 230, a network 235, the service provider server 240, a third party server 250, an advertising services server 260, and an interaction analysis server 270.

Some or all of the interaction analysis server 270, advertisement services server 260, service provider server 240, and third-party server 250 may be in communication with each other by way of network 235. The interaction analysis server 270, advertisement services server 260, third-party server 250 and service provider server 240 may each represent multiple linked computing devices. Multiple distinct third party servers, such as the third-party server 250, may be included in the network environment 200. A portion or all of the interaction analysis server 270, advertisement services server 260 and/or the third-party server 250 may be a part of the service provider server 240. Alternatively or in addition the interaction analysis server 270 may be in direct communication with the service provider server 240.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. Similarly, the users 120A-N may use a web application 220A, a standalone application 220B, or a mobile application 220N to communicate to the service provider server 240, via the networks 230, 235.

The service provider server 240 may communicate to the revenue generators 110A-N via the networks 230, 235, through the web applications, standalone applications or mobile applications 210A-N. The service provider server 240 may also communicate to the users 120A-N via the networks 230, 235, through the web applications, standalone applications or mobile applications 220A-N.

The web applications, standalone applications and mobile applications 210A-N, 220A-N may be connected to the network 230 in any configuration that supports data transfer. This may include a data connection to the network 230 that may be wired or wireless. Any of the web applications, standalone applications and mobile applications 210A-N, 220A-N may individually be referred to as a client application. The web applications 210A, 220A may run on any platform that supports web content, such as a web browser or a computer, a mobile phone, personal digital assistant (PDA), pager, network-enabled television, digital video recorder, such as TIVO®, automobile and/or any appliance capable of data communications.

The standalone applications 210B, 220B may run on a machine that may have a processor, memory, a display, a user interface and a communication interface. The processor may be operatively connected to the memory, display and the interfaces and may perform tasks at the request of the standalone applications 210B, 220B or the underlying operating system. The memory may be capable of storing data. The display may be operatively connected to the memory and the processor and may be capable of displaying information to the revenue generator B 110B or the user B 120B. The user interface may be operatively connected to the memory, the processor, and the display and may be capable of interacting with a user A 120A or a revenue generator A 110A. The communication interface may be operatively connected to the memory, and the processor, and may be capable of communicating through the networks 230, 235 with the service provider server 240, third party server 250 and advertising services server 260. The standalone applications 210B, 220B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, amongst others.

The mobile applications 210N, 220N may run on any mobile device that may have a data connection. The data connection may be a cellular connection, a wireless data connection, an internet connection, an infra-red connection, a Bluetooth connection, or any other connection capable of transmitting data.

The service provider server 240 may include one or more of the following: an application server, a data source, such as a database server, a middleware server, and an advertising services server. The service provider server 240 may co-exist on one machine or may be running in a distributed configuration on one or more machines. The service provider server 240 may collectively be referred to as the server. The service provider may implement a search engine marketing system and/or an advertising campaign management system. The service provider server 240 may receive requests from the users 120A-N and the revenue generators 110A-N and may serve pages to the users 120A-N and the revenue generators 110A-N based on their requests.

The third party server 250 may include one or more of the following: an application server, a data source, such as a database server, a middleware server, and an advertising services server. The third party server may implement a relevancy engine, a context matching engine, or any other third party application that may be used in a search engine marketing system and/or an advertising campaign management system. The third party server 250 may co-exist on one machine or may be running in a distributed configuration on one or more machines. The third party server 250 may receive requests from the users 120A-N and the revenue generators 110A-N and may serve pages to the users 120A-N and the revenue generators 110A-N based on their requests.

The advertising services server 260 may provide a platform for the inclusion of advertisements in pages, such as web pages. The advertisement services server 260 may be used for providing advertisements that may be displayed to the users 120A-N. The advertising services server 260 may implement a search engine marketing system and/or an advertising campaign management system.

The interaction analysis server 270 may be operative to determine the integrity of the interaction, such as by determining if the trustworthiness of the user generating the interaction. The interaction analysis server 270 may access historical user behavior data from the service provider server 240, or some other data source, such as the third party server 250, to determine the tier of trustworthiness of the user A 120A. For example, the interaction analysis server 270 may determine whether the user A 120A user registered for a user ID. In one instance, if the user A 120A has a registered user ID then the user A 120A may be identified as a trusted user and if the user A 120A does not have a registered a user ID the user A 120A may be identified as not trusted user. An interaction generated by a trusted user may be categorized as a high integrity interaction and an interaction generated by an not trusted user may be categorized as a lower integrity interaction. Alternatively or in addition the interaction analysis may be performed by a third party, such as the third party server 250.

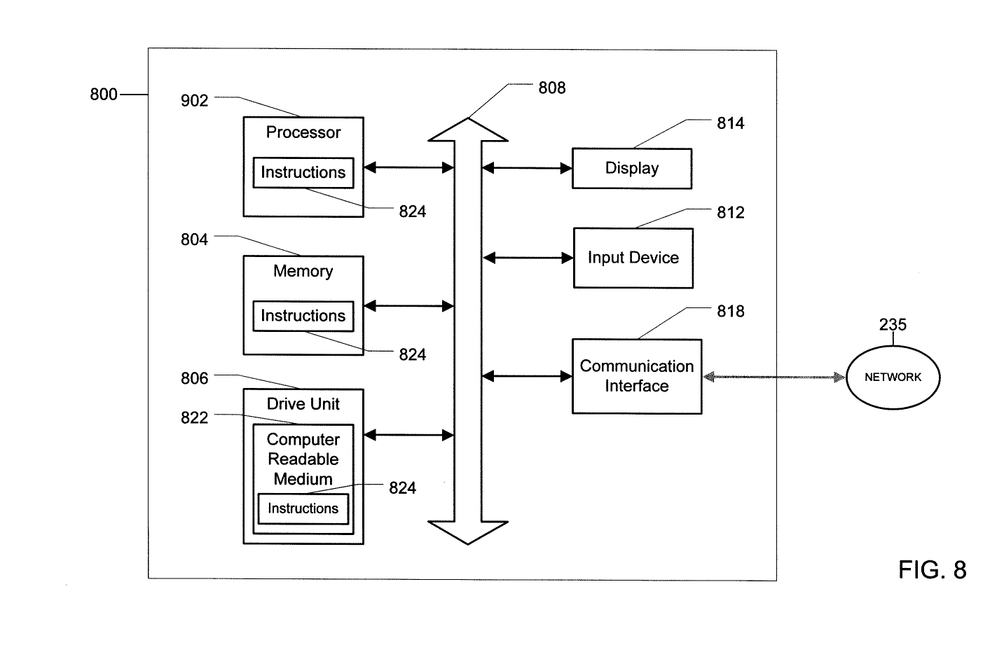

The service provider server 240, the third party server 250, the advertising services server 260, and the interaction analysis server 270 may be one or more computing devices of various kinds, such as the computing device in FIG. 8. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web applications 210A, 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER®, ORACLE®, IBM DB2® or any other database software, relational or otherwise. The application server may be APACHE TOMCAT®, MICROSOFT IIS®, ADOBE COLDFUSION®, YAPACHE® or any other application server that supports communication protocols. The middleware server may be any middleware that connects software components or applications. The middleware server may be a relevancy engine, a context matching engine, or any other middleware that may be used in a search engine marketing system and/or an advertising campaign management system.

The application server on the service provider server 240 or the third party server 250 may serve pages, such as web pages to the users 120A-N and the revenue generators 110A-N. The advertising services server may provide a platform for the inclusion of advertisements in pages, such as web pages. The advertising services server 260 may also exist independent of the service provider server 240 and the third party server 250. The advertisement services server 260 may be used for providing advertisements that may be displayed to users 120A-N on pages, such as web pages.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

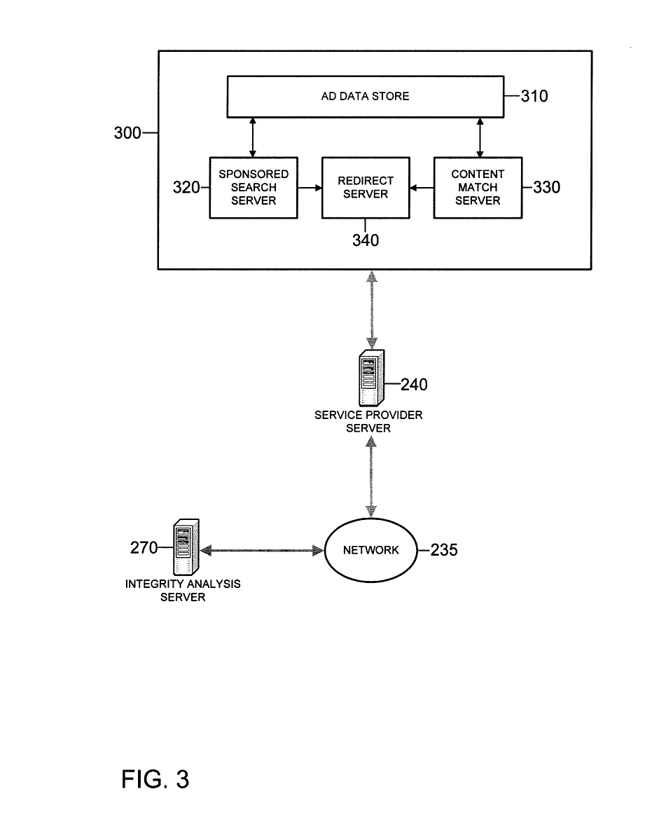

FIG. 3 illustrates an advertisement selection system 300 implementing a system for tiered bidding in an online information system based on the integrity of network interactions. The advertisement selection system 300 may be implemented on the service provider server 240 or the ad services server 260. The advertisement selection system 300 may be an ad serving system, such as an auction-based ad serving system. The advertisement selection system 300 may include an ad data store 310, a sponsored search server 320, a content matching server 330, and a redirect server 340. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The service provider server 240 may receive a request from one of the users 120A-N, such as the user A 120A. The service provider server 240 may request the interaction analysis server 270 to determine the integrity of the interaction with the user A 120A. The interaction analysis server 270 may use historical user behavior data to determine the trustworthiness of the user A 120A. The trustworthiness of the user A 120A may then be used to determine the integrity of the interaction. For example, the interaction analysis server 270 may determine whether the user A 120A registered for a user ID. If the user A 120A registered for a user ID then the user A 120A may be identified as a trusted user. If the user A 120A has not registered a user ID then the user A 120A may be identified as an not trusted user. In this instance the interaction analysis server 270 may then correlate the trustworthiness of the user A 120A to the integrity of the interaction generated by the user A 120A. For example, if the user A 120A is a trusted user the interaction may be categorized as a high integrity interaction and if the user A 120A is a not trusted user then the interaction may be categorized as a low integrity action. The interaction analysis server 270 may return the identified trustworthy categorization, or tier, of the interaction with the user A 120A to the service provider server 240. The service provider server 240 may forward the integrity tier of the interaction tier to the advertisement selection system 300, along with the original request from the user A 120A. Alternatively or in addition the interaction analysis server 270 may forward the user trustworthiness tier directly to the advertisement selection system 300. Alternatively or in addition the interaction analysis server 270 may be in direct communication with the advertisement selection system 300 and/or the service provider server 240.

The ad data store 310 may be operative to store advertisement listings. The ad data store 310 may include one or more relational databases or other data stores that may be managed using various known database management techniques, such as, for example, SQL and object-based techniques. Alternatively or in addition the ad data store 310 may be implemented using one or more of the magnetic, optical, solid state or tape drives. The ad data store 310 may include data fields for the bid amounts of each of the interaction integrity tiers, or categorizations. Alternatively or in addition the ad data store 310 may include a data field for a user premium percentage value.

The sponsored search server 320 may be operative to process sponsored search listing requests from the client applications 210A-N. When a request for a sponsored search listing comes from service provider server 240, the sponsored search server 320 may query the ad data store 310 for any advertisements matching the specified search terms. If matching data, such as ad listings, are available in the ad data store 310, the sponsored search server 320 may retrieve the ads from the data store 310.

The content matching server 330 may operate in a similar manner. The content matching server 330 may be operative to process content match listing requests from the service provider server 240. When a request for a content match listing comes from the service provider server 240, the content matching server 330 may query the ad data store 310 for advertisements, matching the specified search terms. If ad listings, are available in the ad data store 310, the content match server 330 may retrieve the ad listings from the ad data store 310.

Before returning the retrieved ad listings to the service provider server 240, the advertisement selection server 300 may order the ad listings. The ad listings may be retrieved from any combination of the sponsored search server 320, or the content matching server 330. The advertisement selection server 300 may order the advertisements based on several factors, such as the relevance of the ad listings to the keyword searched for, the amount the revenue generators 110A-N bid on the keyword for the interaction integrity tier of the current interaction, any combination of these factors, or any other method of ordering the ad listing. The relevancy may be determined by a relevancy engine implemented on the service provider server 240 or the third party server 250. The relevancy may be combined with the bid price of the revenue generators 110A-N for the advertisements, such as by multiplying the relevancy by the bid price. In the case of the amount bid on the keyword for the integrity tier of the current interaction, the ad listings may be ordered whereby matching ads with the highest bids are displayed first followed by the lower bid advertisements.

Alternatively or in addition, the advertisement selection server 300 may determine whether to serve an ad listing of one of the revenue generators 110A-N, such as the revenue generator A 110A, based on whether the revenue generator A 110A opted in to the minimum percentage of the highest integrity interactions option. If the revenue generator A 110A opted in, the advertisement selection server 300 may order the ad listing of the revenue generator A 110A based on the current monthly percentage of the highest integrity interactions associated with the revenue generator A 110A. If the monthly percentage is below the minimum specified by the revenue generator A 110A the ad listing of the revenue generator A 110A may be ordered higher when requested by a high integrity interaction. If the monthly percentage is above the minimum specified by the revenue generator A 110A, the ad listing of the revenue generator A 110A may be ordered lower, or may not be displayed at all, when requested by a high integrity interaction.

After ordering the advertisements, the advertisement selection server 300 may return the ordered advertisements to the service provider server 240. The service provider server 240 may serve the advertisements, such as sponsored listings, to the client applications 210A-N.

When a user 120A-N clicks on linked data, such as an advertisement, provided by the one of the client applications 210A-N, the browser of a user, such as the user A 120A, may be directed to the redirect server 340 of the advertisement selection system 300. The redirect server 340 may log the click event and redirect the browser of the user A 120A to the URL of the web property specified in the displayed advertisements. The redirect server 340 may store the click event in the ad data store 310, or in any other data store, for ad performance evaluation purposes.

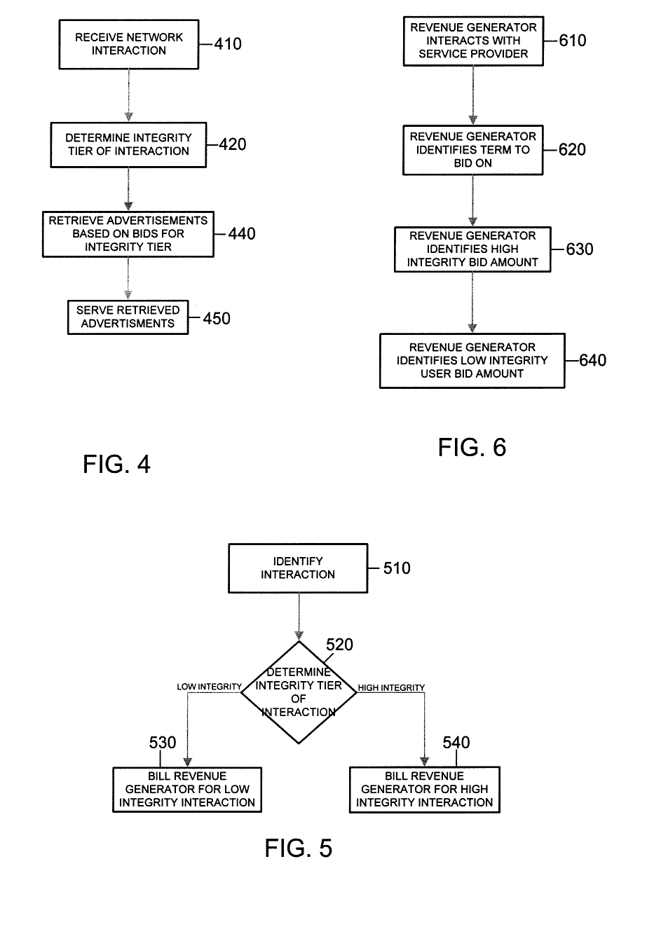

FIG. 4 is a flow chart illustrating one embodiment of operations of serving advertisements in the system implemented in FIG. 1, or other systems for tiered bidding in an online information system based on the integrity of network interactions. At block 410 the service provider server 240 may receive a network interaction, such as a search request from the user A 120A. At block 420, the service provider server 240 may determine the trustworthiness of the user A 120A. The trustworthiness of the user A 120A may then be used to determine the integrity of the interaction and the integrity tier the interaction may fall into. The service provider server 240 may perform the interaction integrity analysis or may request the interaction analysis server 270 to determine the integrity of the interaction.

The interaction analysis server 270 may determine whether the user A 120A registered for a user ID through the service provider 240. If the user A 120A previously registered for a user ID, the user A 120A may be identified as a trusted user. If the user A 120A did not previously register for a user ID, the user A 120A may be identified as an not trusted user. If the user A 120A is unidentifiable, the user A 120A may be identified as an unknown user. The integrity of the interaction may then be determined based on the identified trustworthiness of the user A 120A. If the user A 120A is identified as a trusted user the interaction may be categorized as a high integrity interaction, and if the user A 120A is identified as a not trusted user or an unknown user, the interaction may be categorized as an low integrity interaction. A high integrity interaction may fall into the high integrity interaction tier and a low integrity interaction may fall into the low integrity interaction tier. Alternatively or in addition an interaction generated by an unidentifiable user may be categorized separately from interactions generated by not trusted users. Alternatively or in addition other data relevant to the interaction may be used separately, or in conjunction with the user data, to determine the integrity of the interaction.

At block 440 the service provider server 240 may retrieve advertisements to serve to the user A 120A based on the integrity tier of the interaction identified in block 420. The service provider server 240 may forward the search request and the interaction integrity tier to the advertisement selection system 300. The advertisement selection system 300 may select advertisements for display to the user A 120A based on the integrity tier of the interaction generated by the user A 120A. For example, if the interaction is categorized as a low integrity interaction, the advertisement selection system 300 may use the low integrity bids of the revenue generators 110A-N for the search term. The advertisement selection system 300 may order the advertisements based on the bid amounts of the revenue generators 110A-N for the integrity tier of the interaction, whereby matching ads with the highest bids are displayed first followed by the lower bid advertisements. Alternatively or in addition the advertisement selection system 300 may order the advertisements based on the relevancy of the advertisements to the keyword searched for, the relevancy of the advertisements to the data on the page, any other identifiable factor, or any combination of the aforementioned factors. The advertisement selection system 300 may return the selected advertisements to the service provider 240 for serving to the user A 120A.

At block 450, the service provider server 240 may serve the retrieved advertisements to the user A 120A, such as by adding the advertisements to a search results page. The service provider server 240 may add the advertisements to the page containing the results of the search requested by the user A 120A. The search results page with the added advertisements may then be served to the user A 120A via the network 230. The search results page with the advertisements may be displayed to the user A 120A, such as through a web browser.

FIG. 5 is a flow chart illustrating one embodiment of operations of determining the amount to bill a revenue generator in the system of FIG. 1, or other systems for tiered bidding in an online information system based on the integrity of network interactions. At block 510 the service provider server 240 may identify an interaction, such as click through by one of the users 120A-N on an advertisement of one of the revenue generators 110A-N, such as the revenue generator A 110A.

At block 520, the service provider server 240 may determine the integrity tier of the interaction generated by the user A 120A, such as the click-through. The service provider server 240 may determine the integrity tier of the interaction generated by the user A 120A or the service provider server 240 may request the interaction analysis server 270 to determine the integrity tier of the interaction. For example, the interaction analysis server 270 may determine whether the user A 120A registered for a user ID through the service provider 240. If the user A 120A previously registered for a user ID, the user A 120A may be identified as a trusted user. If the user A 120A did not previously register for a user ID, the user A 120A may be identified as a not trusted user. If the user A 120A is unidentifiable, the user A 120A may be identified as a unknown user. In the case of a trusted user the interaction may be categorized as a high integrity interaction. In the case of a not trusted or unknown user, the interaction may be categorized as a low integrity interaction. Alternatively or in addition an unidentifiable user may be placed in a separate tier for unidentifiable users.

If the service provider server 240 determines that the interaction is a high integrity interaction, then the system 100 may move to block 540. At block 540 the revenue generator A 110A may be billed the amount bid on for a high integrity interaction for the given search term. The service provider server 240 may retrieve the bid amount from the ad data store 310, or any other data source storing the bid amounts of the revenue generators 110A-N. The bid amount may refer to the amount bid on by the revenue generator for high integrity interactions relating to the search term that resulted in the display of the advertisement clicked through by the user A 110A. The service provider server 240 may debit the account of the revenue generator A 110A for the amount bid on the search term for high integrity interactions. Alternatively or in addition the service provider server 240 may store the data to debit the account of the revenue generator A 110A at a later time.

If the service provider server 240 determines that the interaction is a low integrity interaction the system 100 may move to block 530. At block 540 the revenue generator A 110A may be billed the amount bid on for a low integrity interaction. The service provider server 240 may retrieve the bid amount from the ad data store 310, or any other data source storing the bid amounts of the revenue generators 110A-N. The bid amount may refer to the amount bid on by the revenue generator for low integrity interactions relating to the search term that resulted in the display of the advertisement clicked through by the user A 110A. The service provider server 240 may debit the account of the revenue generator A 110A for the amount bid on the search term for low integrity interactions. Alternatively or in addition the service provider server 240 may store the data to debit the account of the revenue generator A 110A at a later time.

FIG. 6 is a flow chart illustrating an embodiment of steps taken by a revenue generator when bidding on tiered interactions based on the integrity of the interaction in the system implemented in FIG. 1, or other systems for tiered bidding in an online information system based on the integrity of network interactions. At block 610 one of the revenue generators 110A-N, such as the revenue generator A 110A may interact with the service provider 240, such as by logging in to the service provider 240. At block 620 the revenue generator A 110A may identify a term, or group or terms, the revenue generator A 110A may wish to bid on. The revenue generator A 110A may be presented with the option to specify a separate bid for each interaction integrity tier identified by the service provider 130. Alternatively or in addition, the revenue generator A 110A may be presented with the option to specify a separate bid for a separate trust tier of the users 120A-N, as identified by the service provider 130.

At block 630 the revenue generator A 110A may identify a bid amount for the term or group of terms for high integrity interactions. High integrity interactions may be generated by trusted users, such as users 120A-N who have satisfied a condition, such as registering a user ID with the service provider 130. At block 640 the revenue generator A 110A may identify a bid amount for the term or group of terms for low integrity interactions. Low integrity interactions may be generated by not trusted users, such as users 120A-N who have not satisfied a condition, such as registering a user ID with the service provider 130.

The interaction analysis server 270 may determine whether users 120A-N interacting with the service provider 130 are trusted users or not trusted users. The trustworthiness of the users 120A-N may then be used to identify the integrity of the interaction. Alternatively or in addition there may be a plurality of tiers identifying the integrity of the interactions. The revenue generators 110A-N may place a bid on one or more of the interaction integrity tiers for each term or group of terms.

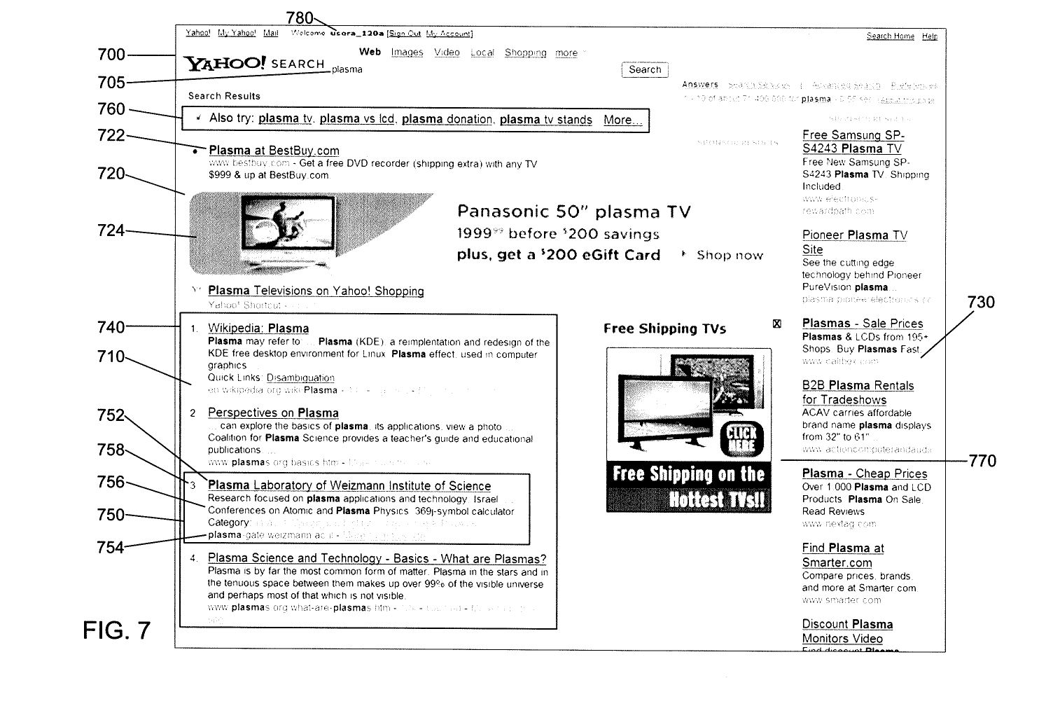

FIG. 7 is a screenshot of a page 700 displaying advertisements to the users 120A-N served from a search engine marketing system implementing a system of tiered bidding in an online information system based on the integrity of network interactions. The page 700 may be displayed to one of the users 120A-N, such as the user A 120A, when the user A 120A searches for the term “plasma.”The page 700 may include a search query 705, content 710, query suggestions 760, top ads 720, side ads 730 and a popup ad 770. The content 710 may include a search results list 740 based on the search query 705 submitted by the user A 120A, such as “plasma”. The search results list 740 may include one or more search results 750. A search result 750 may include a title link 752, a URL 754, a description 756 and a rank 758. The top ads 720 may include a sponsor listing 722 and a banner ad 724. The side ads 730 include sponsored listings. The query suggestions 760 may represent queries that were suggested by the service provider 130. The queries may represent phrases similar to the search query 705 that users 120A-N searched for.

The title link 752 may be a clickable link that may reference a site. If one the users 120A-N, such as the user A 120A, clicks on the title link 752, the user A 120A may be forwarded to the site referred to by the title link 752. The site referred to by the title link 752 may be described in the description 756. The URL 754 may represent the URL of the site referred to by the link 752. The rank 758 may represent the order of the search result 750 in the search results list 740.

The top ads 720 and the side ads 730 may include any combination of sponsored listings, banner ads and popup ads. The top ads 720 and the side ads 730s may represent advertisements that may have been retrieved from the sponsored search server 320, the content match server 330 or in accordance with the operations of FIG. 4. The sponsored listing 722 and/or the banner ad 724 may link the users 120A-N to the web site of a revenue generator, such as the revenue generator A 110A, when the users 120A-N click on the banner ad 724 and/or the sponsored listing 722. The banner ad 724 may be constructed from an image (GIF, JPEG, PNG), a JavaScript program or a multimedia object employing technologies such as Java, Shockwave or Flash. The banner ad 724 may employ animation, video, or sound to maximize presence. The images used in the banner ad 724 may be in a high-aspect ratio shape (i.e. either wide and short, or tall and narrow).

The popup ad 770 may link the users 120A-N to the web site of a revenue generator, such as the revenue generator A 110A, when the users 120A-N click on the popup ad 770. The popup ad 770 may be constructed from an image (GIF, JPEG, PNG), a JavaScript program or a multimedia object employing technologies such as Java, Shockwave or Flash. The popup ad 770 may employ animation, video, or sound to maximize presence. The popup ad 770 may run in the same window as the page, or may open in a new window. The popup ad 770 may be capable of being closed and/or minimized by clicking on an ‘X’ in the corner of the popup ad 770.

The account of the revenue generator A 110A may be charged when the user A 120A clicks on any of the ads of the revenue generator A 110A. The interaction analysis server 270 may determine the interaction integrity tier the interaction generated by the user A 120A. The account of the revenue generator A 110A may be charged based on the bid amount of the revenue generator A 110A for the determined integrity tier of the interaction.

FIG. 8 illustrates a general computer system 800, which may represent a service provider server 240, a third party server 250, an advertising services server 260, a interaction analysis server 270, or any of the other computing devices referenced herein. The computer system 800 may include a set of instructions 824 that may be executed to cause the computer system 800 to perform any one or more of the methods or computer based functions disclosed herein. The computer system 800 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 824 (sequential or otherwise) that specify actions to be taken by that machine. In a particular embodiment, the computer system 800 may be implemented using electronic devices that provide voice, video or data communication. Further, while a single computer system 800 may be illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, such as, a central processing unit (CPU), a graphics processing unit (GPU), or both. The processor 802 may be a component in a variety of systems. For example, the processor 802 may be part of a standard personal computer or a workstation. The processor 802 may be one or more general processors, digital signal processors, application specific integrated circuits, field programmable gate arrays, servers, networks, digital circuits, analog circuits, combinations thereof, or other now known or later developed devices for analyzing and processing data. The processor 802 may implement a software program, such as code generated manually (i.e., programmed).

The computer system 800 may include a memory 804 that can communicate via a bus 808. The memory 804 may be a main memory, a static memory, or a dynamic memory. The memory 804 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 804 may include a cache or random access memory for the processor 802. Alternatively or in addition, the memory 804 may be separate from the processor 802, such as a cache memory of a processor, the system memory, or other memory. The memory 804 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 804 may be operable to store instructions 824 executable by the processor 802. The functions, acts or tasks illustrated in the figures or described herein may be performed by the programmed processor 802 executing the instructions 824 stored in the memory 804. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 800 may further include a display 814, such as a liquid crystal display (LCD), an organic light emitting diode (OLED), a flat panel display, a solid state display, a cathode ray tube (CRT), a projector, a printer or other now known or later developed display device for outputting determined information. The display 814 may act as an interface for the user to see the functioning of the processor 802, or specifically as an interface with the software stored in the memory 804 or in the drive unit 806.

Additionally, the computer system 800 may include an input device 812 configured to allow a user to interact with any of the components of system 800. The input device 812 may be a number pad, a keyboard, or a cursor control device, such as a mouse, or a joystick, touch screen display, remote control or any other device operative to interact with the system 800.

The computer system 800 may also include a disk or optical drive unit 806. The disk drive unit 806 may include a computer-readable medium 822 in which one or more sets of instructions 824, e.g. software, can be embedded. Further, the instructions 824 may perform one or more of the methods or logic as described herein. The instructions 824 may reside completely, or at least partially, within the memory 804 and/or within the processor 802 during execution by the computer system 800. The memory 804 and the processor 802 also may include computer-readable media as discussed above.

The present disclosure contemplates a computer-readable medium 822 that includes instructions 824 or receives and executes instructions 824 responsive to a propagated signal; so that a device connected to a network 235 may communicate voice, video, audio, images or any other data over the network 235. Further, the instructions 824 may be transmitted or received over the network 235 via a communication interface 818. The communication interface 818 may be a part of the processor 802 or may be a separate component. The communication interface 818 may be created in software or may be a physical connection in hardware. The communication interface 818 may be configured to connect with a network 235, external media, the display 814, or any other components in system 800, or combinations thereof. The connection with the network 235 may be a physical connection, such as a wired Ethernet connection or may be established wirelessly as discussed below. Likewise, the additional connections with other components of the system 800 may be physical connections or may be established wirelessly. In the case of a service provider server 240, a third party server 250, an advertising services server 260, the servers may communicate with users 120A-N and the revenue generators 110A-N through the communication interface 818.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 822 may be a single medium, or the computer-readable medium 822 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 822 may include a solid-state memory such as a memory card or other package that houses one or more non-volatile read-only memories. The computer-readable medium 822 also may be a random access memory or other volatile re-writable memory. Additionally, the computer-readable medium 822 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method for tiered bidding in an online information system based on the integrity of network interactions, comprising:
identifying a plurality of integrity tiers representing a plurality of integrity levels of a plurality of network interactions;
receiving a plurality of bid amounts associated with the plurality of integrity tiers for a term; and
storing the plurality of bid amounts associated with the plurality of integrity tiers for the term in a data structure.

2. The method of claim 1 wherein the plurality of integrity tiers comprises a high integrity tier and a low integrity tier.

3. The method of claim 2 wherein the high integrity tier represents a network interaction likely to be valid.

4. The method of claim 3 wherein the high integrity tier represents a network interaction generated by a user with a user ID.

5. The method of claim 2 wherein the low integrity tier represents a network interaction likely to be invalid.

6. The method of claim 5 wherein the low integrity tier represents a network interaction generated by a user without a user ID.

7. The method of claim 1 wherein the data structure comprises a database.

8. The method of claim 1 wherein the plurality of bid amounts are received from an advertiser.

9. A method for serving advertisements based on the integrity of a network interaction relating to a term, comprising:
receiving a network interaction relating to a term;
determining an integrity of the network interaction;
identifying a plurality of bid amounts from a plurality of advertisers associated with the integrity of the network interaction and the term; and
serving a plurality of advertisements from the plurality of advertisers based on the plurality of bid amounts.

10. The method of claim 9 wherein the network interaction comprises a search request.

11. The method of claim 9 wherein the term comprises a term searched for by the user.

12. The method of claim 11 wherein serving a plurality of advertisements from the plurality of advertisers based on the plurality of bid amounts further comprises:
identifying a search results page relating to the term;
adding the plurality of advertisements to the search results page; and
communicating the search results page to the user.

13. The method of claim 11 wherein determining the integrity of the network interaction further comprises analyzing a dataset relating to the user to determine a trustworthiness of the user.

14. The method of claim 9 wherein the integrity of the network interaction comprises at least one of a high integrity network interaction and a low integrity network interaction.

15. The method of claim 14 wherein the high integrity network interaction represents a network interaction likely to be valid.

16. The method of claim 14 wherein the low integrity network interaction represents a network interaction likely to be invalid.

17. A system for tiered bidding in an online information system based on the integrity of network interactions, comprising:
a memory to store a plurality of integrity tiers representing a plurality of integrity levels of a plurality of network interactions, a term, and a plurality of bid amounts associated with the plurality of integrity tiers for the term;
an interface operatively connected to the memory, the interface operative to communicate with an advertiser; and
a processor operatively connected to the memory and the interface, the processor operative to identify the plurality of integrity tiers, receiving the plurality of bid amounts from the advertiser associated with the plurality of integrity tiers for the term, and storing the plurality of bid amounts in the memory.

19. The method of claim 18 wherein the term comprises a search term in a search engine marketing system.

20. The method of claim 18 wherein the plurality of integrity tiers comprises a high integrity tier and a low integrity tier.

21. The method of claim 20 wherein the high integrity tier represents a network interaction likely to be valid.

22. The method of claim 21 wherein the high integrity tier comprises a network interaction generated by a user with a user ID.

23. The method of claim 20 wherein the low integrity tier comprises a network interaction likely to be invalid.

24. The method of claim 23 wherein the low integrity tier comprises a network interaction generated by a user without a user ID.

25. The method of claim 18 wherein the plurality of bid amounts are determined by a multiplier.
